(19) United States
(12) Patent Application Publication
(10) Pub. No.: US 2018/0070089 A1
(43) Pub. Date: Mar. 8, 2018

(54) SYSTEMS AND METHODS FOR DIGITAL IMAGE STABILIZATION

(71) Applicant: QUALCOMM Incorporated, San Diego, CA (US)

(72) Inventors: Yunke Pan, San Diego, CA (US); Shuxue Quan, San Diego, CA (US)

(21) Appl. No.: 15/260,281

(22) Filed: Sep. 8, 2016

(51) Int. Cl. H04N 19/139; H04N 19/15; H04L 12/801; H04N 19/60

(52) U.S. Cl. CPC H04N 19/139; H04N 19/15; H04N 19/174; H04N 19/60; H04L 47/29

(57) ABSTRACT

A method of digital image stabilization is described. The method includes performing feature-based digital image stabilization (DIS) on an image. The method also includes using output of a global motion detector to correct the feature-based DIS on the image. Using output of the global motion detector may include projecting the image on horizontal slices and vertical slices to create blocks. Motion vectors of each block in the image may be calculated. If at least one block motion vector is determined to be a valid block motion vector, then a global motion vector may be determined from all valid block motion vectors.

### FIELD OF DISCLOSURE

The present disclosure relates generally to electronic devices. More specifically, the present disclosure relates to systems and methods for digital image stabilization.

### BACKGROUND

In the last several decades, the use of electronic devices has become common. In particular, advances in electronic technology have reduced the cost of increasingly complex and useful electronic devices. Cost reduction and consumer demand have proliferated the use of electronic devices such that they are practically ubiquitous in modern society. As the use of electronic devices has expanded, so has the demand for new and improved features of electronic devices. More specifically, electronic devices that perform new functions and/or that perform functions faster, more efficiently or with higher quality are often sought after.

Some electronic devices (e.g., cameras, video camcorders, digital cameras, cellular phones, smart phones, computers, televisions, etc.) capture and/or utilize images. For example, a smartphone may capture and/or process still and/or video images. Processing images may demand a relatively large amount of time, memory and energy resources. The resources demanded may vary in accordance with the complexity of the processing.

It may be difficult to implement some complex processing tasks. For example, an electronic device may perform feature-based digital image stabilization (DIS). However, in some cases, feature-based DIS may fail. As can be observed from this discussion, systems and methods that improve digital image processing may be beneficial.

### SUMMARY

A method of digital image stabilization is described. The method includes performing feature-based digital image stabilization (DIS) on an image. The method also includes using output of a global motion detector to correct the feature-based DIS on the image.

Using output of the global motion detector may include projecting the image on horizontal slices and vertical slices to create blocks. Motion vectors of each block in the image may be calculated. If at least one block motion vector is a valid block motion vector, then a global motion vector may be determined from all valid block motion vectors. Calculating motion vectors of each block may include comparing a segment in each slice to a corresponding segment in a slice of a previous image.

Determining whether a given block motion vector is valid may include determining a motion vector confidence value for the given block motion vector. The motion vector confidence value may be compared to a first predefined threshold.

The global motion vector may include a horizontal global motion vector that is a median of valid block motion vectors in a horizontal direction, and a vertical global motion vector that is a median of valid block motion vectors in a vertical direction.

Using output of the global motion detector may include comparing a global confidence value to a second predefined threshold and comparing a number of features used in the feature-based DIS to a third predefined threshold. The global motion vector may be selected to transform the image when the global confidence value is more than the second predefined threshold and the number of features used in the feature-based DIS is less than the third predefined threshold.

Determining the global confidence value may include determining a horizontal global confidence value for the horizontal global motion vector. A vertical global confidence value may be determined for the vertical global motion vector. The global confidence value may be determined as an average of the horizontal global confidence value and the vertical global confidence value.

An electronic device configured for digital image stabilization is also described. The electronic device includes a processor, memory in communication with the processor and instructions stored in the memory. The instructions are executable by the processor to perform feature-based DIS on an image. The instructions are further executable to use output of a global motion detector to correct the feature-based DIS on the image.

A computer-program product for digital image stabilization is also described. The computer-program product includes a non-transitory tangible computer-readable medium having instructions thereon. The instructions include code for causing an electronic device to perform feature-based DIS on an image. The instructions also include code for causing the electronic device to use output of a global motion detector to correct the feature-based DIS on the image.

### BRIEF DESCRIPTION OF THE DRAWINGS

FIG. 1 is a block diagram illustrating an electronic device configured to perform digital image stabilization;

FIG. 2 is a flow diagram illustrating a method for performing digital image stabilization;

FIG. 3 is a block diagram illustrating one configuration of an image processor;

FIG. 4 is a block diagram illustrating one configuration of a global motion detector and a fusion module;

FIG. 5 is an example illustrating partitioning of an image into slices and blocks;

FIG. 6 is an example illustrating a block motion vector determination;

FIG. 7 is a flow diagram illustrating another method for performing digital image stabilization; and

FIG. 8 illustrates certain components that may be included within an electronic device.

### DETAILED DESCRIPTION

An electronic device may perform digital image stabilization (DIS) on one or more images in an image sequence. For example, an electronic device may be configured with a camera that records a video of a scene of interest. The electronic device may perform DIS to reduce or eliminate camera motion (e.g., shake or jitter). For example, it may be desirable to stabilize a video captured by a camera that is mounted on an unstable platform (e.g., human hand, an unmanned aerial vehicle (UAV), car, outside pole). One DIS approach that may be performed is a feature-based solution.

Feature-based DIS is effective to correct motion based artifacts in feature-rich images. However, feature-based DIS may fail in certain cases. For example, feature-based DIS may fail for subjects that lack sufficient features, such as the sky. In this case, the feature-based DIS results are very unreliable. In another case, feature-based DIS may fail when features in the scene are dominated by local moving object (e.g., an airplane or birds flying through the sky). In this case, feature-based DIS may follow the local moving object, which eventually moves out of view. This may fail to correct the camera shake.

The systems and methods described herein solve these problems and enhance feature-based DIS. The electronic device may include a global motion detector to complement (or correct) translation when feature-based DIS fails. The global motion detector may be low-cost in terms of processing and resource (e.g., power) consumption.

The systems and methods described herein provide for using output of the global motion detector to correct the feature-based DIS on an image. Generally, global motion detector has a high computational cost, which is more than mobile devices can provide. To reduce the computational cost, a 2-dimensional motion vector search is converted into a 1-dimension match by image projection.

The image may be virtually partitioned into blocks by partitioning the projections into line segments. Based on the projections, motion vectors of each block can be estimated. A global motion vector may be generated from the valid motion vectors of blocks. The confidence of this global motion vector is also calculated. Finally, the confidence is used to choose the transform from the low-cost global motion detector or the feature-based DIS. Systems and methods of performing digital image stabilization are explained in greater detail below.

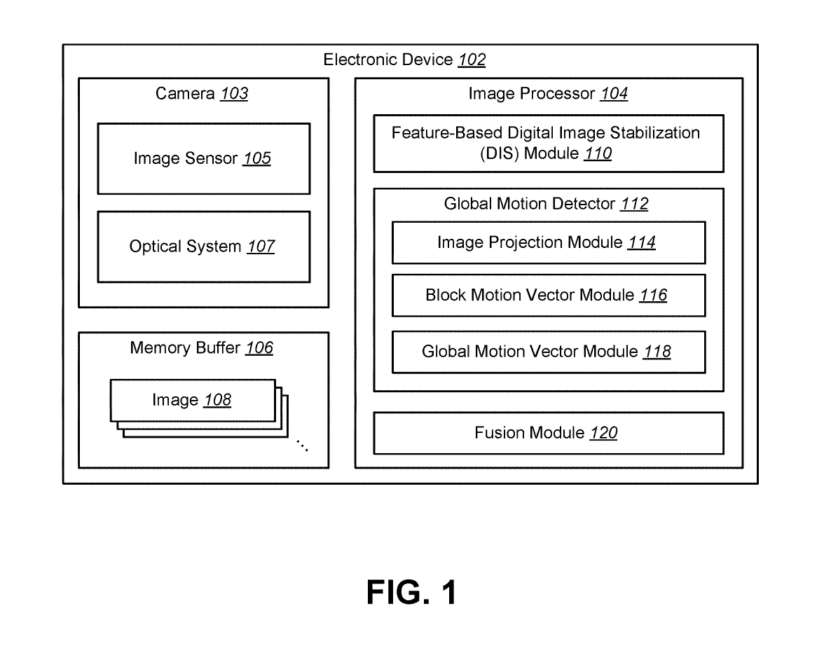

FIG. 1 is a block diagram illustrating an electronic device 102 configured to perform digital image stabilization. The electronic device 102 may also be referred to as a wireless communication device, a mobile device, mobile station, subscriber station, client, client station, user equipment (UE), remote station, access terminal, mobile terminal, terminal, user terminal, subscriber unit, etc. Examples of electronic devices include laptop or desktop computers, cellular phones, smart phones, wireless modems, e-readers, tablet devices, gaming systems, robots, aircraft, unmanned aerial vehicles (UAVs), automobiles, etc. Some of these devices may operate in accordance with one or more industry standards.

In many scenarios, the electronic device 102 may perform digital image stabilization (DIS) on one or more images 108 in an image sequence. In an implementation, an electronic device 102 may include one or more cameras 103. A camera 103 may include an image sensor 105 and an optical system 107 (e.g., lenses) that focuses images of objects that are located within the field of view of the optical system 107 onto the image sensor 105. An electronic device 102 may also include a camera software application and a display screen. When the camera application is running, images 108 of objects that are located within the field of view of the optical system 107 may be recorded by the image sensor 105. These images 108 may be stored in a memory buffer 106. In some implementations, the camera 103 may be separate from the electronic device 102 and the electronic device 102 may receive image data from one or more cameras 103 external to the electronic device 102. In yet another implementation, the electronic device 102 may receive image data from a remote storage device.

To capture the image 108, an image sensor 105 may expose image sensor elements to the image scene to capture the image 108. The image sensor elements within image sensor 105 may, for example, capture intensity values representing the intensity of the light of the scene at a particular pixel position. In some cases, each of the image sensor elements of the image sensor 105 may only be sensitive to one color, or color band, due to the color filters covering the image sensor elements. For example, the image sensor 105 may comprise, for example, an array of red, green and blue filters. The image sensor 105 may utilize other color filters, however, such as cyan, magenta, yellow and key (CMYK) color filters. Thus, each of the image sensor elements of image sensor 105 may capture intensity values for only one color. Thus, the image information may include pixel intensity and/or color values captured by the image sensor elements of image sensor 105.

Although the present systems and methods are described in terms of captured images 108, the techniques discussed herein may be used on any digital image. For example, the images 108 may be frames from a video sequence. Therefore, the terms video frame and digital image may be used interchangeably herein.

The electronic device 102 may perform DIS to reduce or eliminate camera motion (e.g., shake or jitter). For example, it may be desirable to stabilize a video captured by a camera 103 that is mounted on an unstable platform (e.g., an unmanned aerial vehicle (UAV), car, outside pole).

The electronic device 102 may include an image processor 104 that performs DIS on one or more images 108. The image processor 104 receives the image information for two or more images 108 (or frames), e.g., from a memory buffer 106, and performs the image stabilization techniques described in this disclosure. In particular, the image processor 104 includes a feature-based DIS module 110, a global motion detector 112 and a fusion module 120.

The image processor 104 may be realized by one or more microprocessors, digital signal processors (DSPs), application specific integrated circuits (ASICs), field programmable gate arrays (FPGAs), or any other equivalent discrete or integrated logic circuitry, or a combination thereof. In some implementations, image processor 104 may form part of an encoder-decoder (CODEC) that encodes the image information according to a particular encoding technique or format, such as Motion Pictures Expert Group (MPEG)-2, MPEG-4, International Telecommunication Union (ITU) H.263, ITU H.264, Joint Photographic Experts Group (JPEG), Graphics Interchange Format (GIF), Tagged Image File Format (TIFF) or the like. The image processor 104 may perform additional processing on the image information, such as image cropping, compression, enhancement and the like.

It should be noted that the depiction of different features as units or modules is intended to highlight different functional aspects of image processing that may be performed by the image processor 104, and does not necessarily imply that such units or modules must be realized by separate hardware, software and/or firmware components. Rather, functionality associated with one or more units or modules may be integrated within common hardware, software components and/or firmware components.

The feature-based DIS module 110 may perform feature-based DIS on the one or more images 108. Feature-based DIS is good for feature-rich images 108. The feature-based DIS module 110 may generate a transform to compensate for camera motion (e.g., shake or jitter) based on feature detection in an image 108.

However, feature-based DIS may fail in certain cases. In one case, feature-based DIS may fail for images 108 that lack sufficient features. Examples of feature-deficient images 108 include images 108 of the sky or water. In this case, the feature-based DIS results are very unreliable.

In another case, feature-based DIS may fail when features in the images 108 are concentrated in a moving object. For example, in an image 108 of an airplane or birds flying through the sky, the features may be concentrated in the airplane or birds. In this case, feature-based DIS may follow the local moving object. However, this moving object may eventually move out of view of the camera 103. In these cases, feature-based DIS may fail to correct the camera 103 shake.

To compensate for the shortcomings of feature-based DIS, the image processor 104 may use the output of the global motion detector 112 to correct the feature-based DIS on the image 108. The global motion detector 112 may include an image projection module 114, a block motion vector module 116 and a global motion vector module 118.

In typical approaches, global motion detection requires significant computational resources. This is due to global motion performing a two-dimensional motion vector search. This computational cost may be more than mobile devices can provide. To reduce the computational cost, the global motion detector 112 described herein may use image projections to convert a two-dimensional motion vector search into a 1-dimension match.

The image projection module 114 may project the image 108 on horizontal slices and vertical slices to create blocks. A horizontal slice may include a certain number of rows of pixels in the image 108. A vertical slice may include a certain number of columns of pixels.

The horizontal slice projections are summations of the pixel values of a row of pixels of an image slice. Vertical slice projections are summations of the pixel values of a column of pixels of an image slice. The slices partition the image into M×N blocks. In other words, the image 108 is virtually partitioned into blocks by partitioning the projections into line segments.

The block motion vector module 116 may calculate motion vectors of each block in the image 108. For example, the block motion vector module 116 may compare a segment in each slice projection (i.e., horizontal slice projection or vertical slice projection) to a corresponding segment in a slice of a previous image 108. For a given block, the amount of offset from the previous image 108 to the current image 108 is the motion vector for that block.

The block motion vector module 116 may determine whether a given block motion vector is valid. For example, the block motion vector module 116 may determine a motion vector confidence value for the given block motion vector. The block motion vector module 116 may then compare the motion vector confidence value to a first predefined threshold. If the motion vector confidence value is greater than the first predefined threshold, then the given block motion vector is considered valid.

The global motion vector module 118 may determine a global motion vector from all valid block motion vectors. The global motion vector may have a horizontal component and a vertical component. The global motion vector may include a horizontal global motion vector that is a median of valid block motion vectors in a horizontal direction. The global motion vector may also include a vertical global motion vector that is a median of valid block motion vectors in a vertical direction.

The global motion vector module 118 may also determine a global confidence value for the global motion vector. For example, the global motion vector module 118 may determine a horizontal global confidence value for the horizontal global motion vector. The global motion vector module 118 may also determine a vertical global confidence value for the vertical global motion vector. The global motion vector module 118 may then determine the global confidence value as an average of the horizontal global confidence value and the vertical global confidence value.

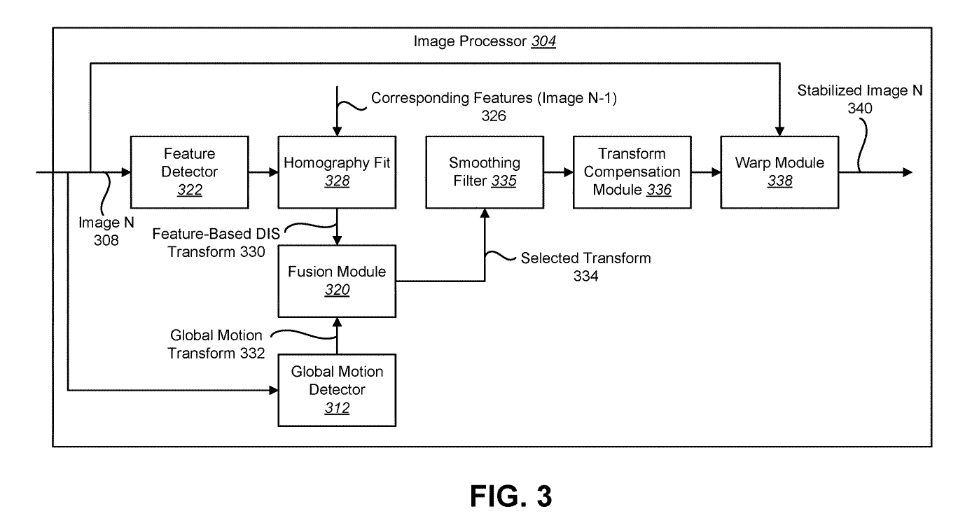

The fusion module 120 may determine whether to use the feature-based DIS or the output of the global motion detector 112 to transform the image 108. The fusion module 120 may compare the global confidence value to a second predefined threshold and the number of features used in the feature-based DIS to a third predefined threshold. The global motion vector may be used to transform the image 108 in lieu of the transform generated by the feature-based DIS module 110 when certain conditions are met. If the global confidence value is more than the second predefined threshold and the number of features used in the feature-based DIS is less than the third predefined threshold, then the fusion module 120 may select the global motion vector to transform the image 108. Otherwise, the fusion module 120 may select the transform generated by the feature-based DIS module 110. More detail on performing digital image stabilization is given in connection with FIG. 3.

The described systems and methods may be used to improve the results of feature-based DIS. For example, in cases where feature-based DIS fails, the global motion detector 112 may compensate for the feature-based DIS. The described global motion detector 112 is also low-cost in that it reduces the computational cost of global motion detection by converting a 2-dimensional motion vector search into a 1-dimension match by image projection. This improves processing efficiency and power consumption in the electronic device 102.

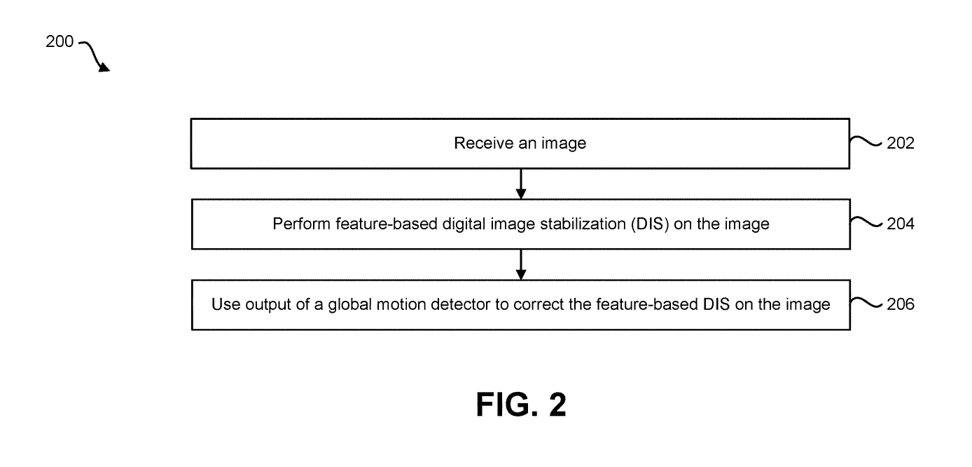

FIG. 2 is a flow diagram illustrating a method 200 for performing digital image stabilization. The method 200 may be implemented by an electronic device 102. For example, the method 200 may be implemented by an image processor 104 of the electronic device 102.

The electronic device 102 may receive 202 an image 108. For example, the electronic device 102 may receive 202 the image 108 from a memory buffer 106 when the image is captured using a camera 103.

The electronic device 102 may perform 204 feature-based digital image stabilization (DIS) on the image 108. The feature-based DIS may generate a transform based on one or more features in the image 108 and a previous image 108.

The electronic device 102 may use 206 output of a global motion detector 112 to correct the feature-based DIS on the image 108. For example, the global motion detector 112 may project the image 108 on horizontal slices and vertical slices to create blocks. The global motion detector 112 may calculate motion vectors of each block in the image 108 based on the image slice projections. The global motion detector 112 may determine if at least one block motion vector is a valid block motion vector. The global motion detector 112 may determine whether a given block motion vector is valid based on a motion vector confidence value for the given block motion vector and a first predefined threshold.

The global motion detector 112 may determine a global motion vector from all valid block motion vectors. The global motion vector may include a horizontal global motion vector that is a median of valid block motion vectors in a horizontal direction. The global motion vector may also include a vertical global motion vector that is a median of valid block motion vectors in a vertical direction. The global motion detector 112 may also determine a global confidence value for the global motion vector. The global motion detector 112 may output the global motion vector and the global confidence value.

The electronic device 102 may use 206 the global motion vector and the global confidence value to correct the feature-based DIS on the image 108. For example, the electronic device 102 may compare the global confidence value to a second predefined threshold and the number of features used in the feature-based DIS to a third predefined threshold. If the global confidence value is more than the second predefined threshold and the number of features used in the feature-based DIS is less than the third predefined threshold, then the electronic device 102 may select the global motion vector to transform the image 108. Otherwise, the fusion module 120 may select the transform generated by the feature-based DIS module 110.

FIG. 3 is a block diagram illustrating one configuration of an image processor 304. The image processor 304 may be implemented within an electronic or wireless device. For example, the image processor 304 of FIG. 3 may be implemented in accordance with the image processor 104 described in connection with FIG. 1.

The image processor 304 may perform digital image stabilization (DIS) of a current image N 308. For example, DIS may be performed for video capture on a portable camera or wireless communication device (e.g., smartphone) to compensate for the jitter from the platform or a user's hand. There are many methods for DIS, including feature-based DIS. The image processor 304 may perform feature-based DIS on the current image N 308.

The features 324 in the current image 308 are detected by a feature detector 322. In an implementation, the feature detector 322 may be a Harris corner detector, fast corner detector, etc. Once the features 324 in current image 308 are located, their corresponding features 326 in a previous image N−1 308 can be determined. To locate the corresponding features 326 in previous image N−1 308, a method such as optical flow or block motion estimation may be applied.

The features 324 and the corresponding features 326 may be provided to a homography fit module 328. In an implementation, the homography fit module 328 may include a random sample consensus (RANSAC) system. A number of pairs of features 324, 326 may be fed into the RANSAC system. In an implementation, the RANSAC system may output a 3×3 matrix (Mᵢⱼ) to best fit the transform from the corresponding features 326 in the previous image N−1 308 to the features 324 in the current image N 308.

The trajectory of movement (the transform 330 from the image-0 308 to the current image N 308) can be built as M₀ⱼ=Mᵢⱼ·M₀ᵢ. This M₀ⱼ matrix may be used as a feature-based transform 330 for the current image N 308.

In traditional feature-based DIS, the transform 330 is provided to a smoothing filter 335. The functionality of smoothing filter 335 is to smooth the trajectory of movement, where SM₀ⱼ=filter(M₀ⱼ). A Kalman filter may be applied in this stage.

The smoothed transform may be provided to a transform compensation module 336. The transform compensation module 336 may compute a compensation matrix (Mⱼ) that transforms from matrix M₀ⱼ to matrix SM₀ⱼ. That is, SM₀ⱼ=Mⱼ·M₀ⱼ. Therefore, Mⱼ=SM₀ⱼ·M₀ⱼ⁻¹. The compensation matrix Mⱼ may be provided to a warp module 338.

Once Mj is known, the stabilized image N (SI) 340 may be computed by warping the current image N 308. This may be expressed as

SI=Mⱼ·N=SM₀ⱼ·M₀ⱼ⁻¹·N. (1)

In most cases, this algorithm for feature-based DIS works well. However, it often fails in the following two cases. In Case 1, video frames do not have sufficient contrast, and there are not enough features 324 for the RANSAC system to generate a stable matrix Mᵢⱼ. In Case 2, the features 324 are concentrated on a moving object in the image 308. Therefore, the matrix Mᵢⱼ stands for object movement instead of global motion. If the feature-based DIS tries to compensate for the movement of objects in the images 308, it does not reduce jitter, but drags an output frame out of camera's field of view.

To achieve better digital image stabilization, a low-cost global motion correction may be used to enhance the feature-based DIS. A low-cost global motion detector 312 and fusion module 320 may be added into feature-based DIS.

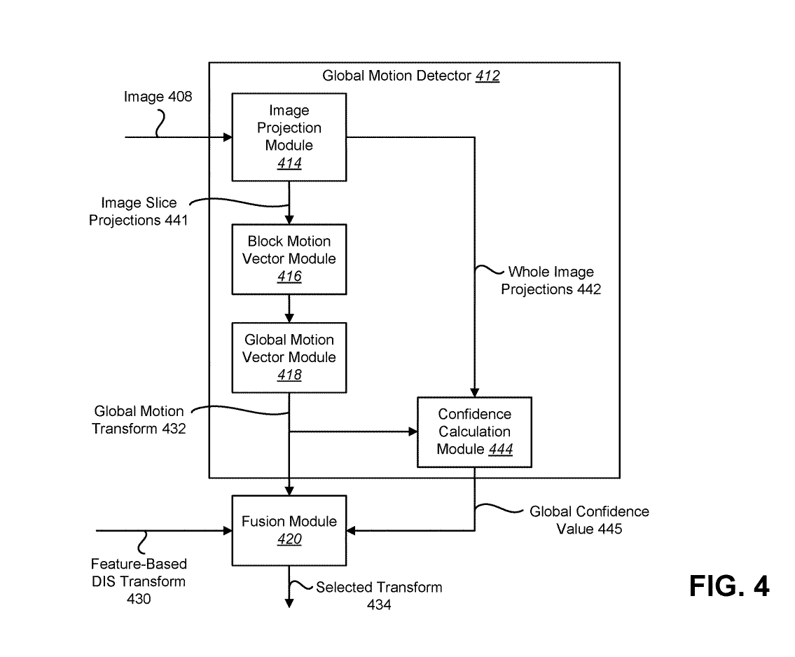

The global motion detector 312 may receive the current image N 308. The global motion detector 312 may then generate a global motion transform 332 for the current image N 308. The global motion transform 332 may be a global motion vector. More detail on the global motion detector 312 and the fusion module 320 is given in connection with FIG. 4.

Two sets of transforms 330, 332 may be generated simultaneously, one from feature-based DIS, the other from the global motion detector 312. The fusion module 320 may select the best transform 330, 332 with which to compute the compensation matrix. The selected transform 334 may be provided to the smoothing filter 335.

FIG. 4 is a block diagram illustrating one configuration of a global motion detector 412 and a fusion module 420. The global motion detector 412 and the fusion module 420 may be implemented within an electronic or wireless device. For example, the global motion detector 412 of FIG. 4 may be implemented in accordance with the global motion detector 112, 312 described in connection with FIG. 1 and FIG. 3, respectively. The fusion module 420 of FIG. 4 may be implemented in accordance with the fusion module 120, 320 described in connection with FIG. 1 and FIG. 3, respectively.

The global motion detector 412 may include an image projection module 414 that receives an image 408. The image projection module 414 may partition the image 408 into a number of slices in both the horizontal and vertical directions. In an implementation, the image projection module 414 partitions the image 408 into N slices in both horizontal and vertical directions. The projection 441 of slice n in the horizontal direction is

$${X}_{n} [ j ] = {\sum }_{i = rows in slice n} ( image [ i , j ] ) . \qquad ( 2 )$$

The whole image projection 442 in the horizontal direction is

$$X [ j ] = {\sum }_{i = rows in image} ( image [ i , j ] ) . \qquad ( 3 )$$

The projection 441 of slice n in the vertical direction is

$${Y}_{n} [ i ] = {\sum }_{j = cols in slice n} ( image [ i , j ] ) . \qquad ( 4 )$$

The whole image projection 442 in the vertical direction is

$$Y [ i ] = {\sum }_{j = cols in image} ( image [ i , j ] ) . \qquad ( 5 )$$

In equations (2) to (5), image(i, j) denotes the pixels on image located at row “i” and column “j.” In this manner, the image projection module 414 generates single-dimension projection vectors that represent the two-dimensional image information of the image 408.

By partitioning the image 408 into slices, the image projection module 414 also partitions the image 408 into blocks. However, it should be noted that this is a virtual step, where the partition is realized by selecting a segment of the horizontal and vertical projections 441. With image projection, the motion vectors may be calculated on image projections 441 instead of 2-dimensional image blocks. This significantly reduces computational cost for motion estimation.

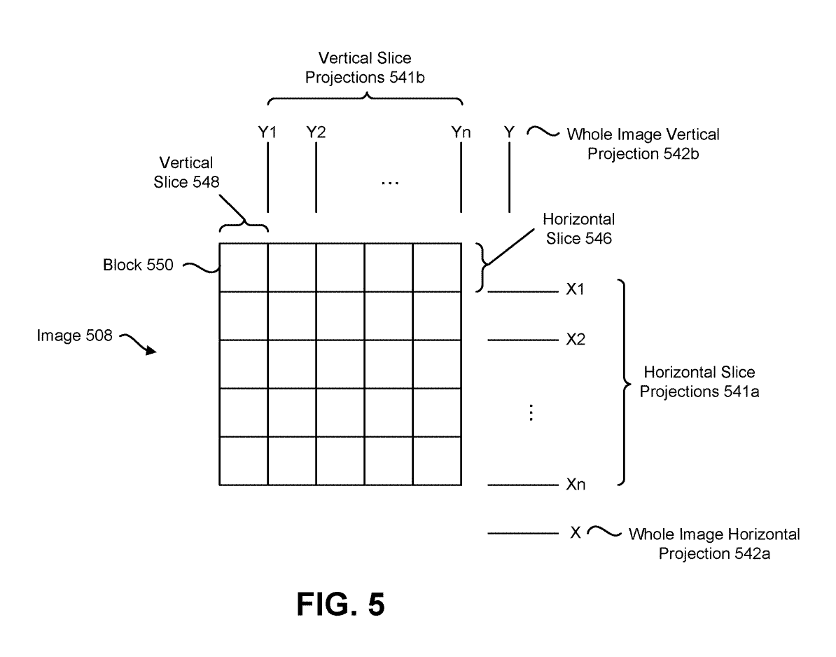

In an implementation, before motion estimation on the image projections 442, each projection 442 may be smoothed by a Gaussian filter. An example of image partitioning is described in connection with FIG. 5.

The block motion vector module 416 may receive the image slice projections 441. After determining the horizontal and vertical slice projection vectors according to respective equations (2), (4) above or any other projection-like function capable of compressing two-dimensional image information into a single dimension, the block motion vector module 416 computes motion vectors for the blocks as a function of the image slice projections 441.

As described, the image 408 is virtually partitioned into blocks (e.g., N×N blocks). Because the motion estimation is based on image projections 441, the image 408 is not actually partitioned. Instead, the image slice projections 441 (i.e., X₁, . . . , X_{N} and Y₁, . . . , Y_{N}) are partitioned into line segments to match the blocks in the image 408. For each block, the block motion vectors (i.e., a horizontal block motion vector and a vertical block motion vector) may be calculated.

In an implementation, the block motion vector module 416 may locate the line segment SX_{n′} on a previous image slice projection X_{n′} 441 for the current block i. The block motion vector module 416 may search SX_{n′} on the current image slice projection Xₙ 441 within a certain search range. The block motion vector module 416 may compare the line segment SX_{n′} with line segments SXₙ on Xₙ. The block motion vector module 416 may calculate the smallest sum of absolute difference (SAD) to find the best match between SX_{n′} and SXₙ. The offset between SX_{n′} and SXₙ is the motion vector MVₓ of block i in the horizontal direction.

The block motion vector module 416 may apply the above procedures on the vertical image slice projections 441 to calculate the vertical motion vector (MV_{y}). For example, the offset between SY_{n′} and SYₙ is the motion vector MVy of block i in the vertical direction.

The block motion vector module 416 may determine motion vector confidence values. In an implementation, the block motion vector module 416 may align SX_{n′} with SXₙ and SY_{n′} with SYₙ. The confidence value (conf) of a given motion vector may be determined as the normalized cross correlation (NCC) between SX_{n′} and SXₙ for a horizontal motion vector MVₓ and the NCC between SY_{n′} and SYₙ for a vertical motion vector (MV_{y}).

The block motion vector module 416 may determine whether a given block motion vector is valid based on the motion vector confidence values. In an implementation, the block motion vector module 416 may compare the motion vector confidence value (conf) to a first predefined threshold. If the motion vector confidence value is greater than the first threshold (i.e., conf>Threshold), then the motion vector (i.e., MVₓ or MV_{y}) is considered a valid motion vector. The block motion vector module 416 may provide the valid motion vectors to the global motion vector module 418.

The global motion vector represents the movement of the whole image 408. The global motion vector may be referred to as the global motion transform 432. From the motion vectors of blocks, the global motion vector can be calculated. In an implementation, the global motion vector includes a horizontal component and a vertical component. A horizontal global motion vector (GMVₓ) may be a median of valid block motion vectors in the horizontal direction (i.e., GMVₓ=median(all valid MVₓ)). A vertical global motion vector (GMV_{y}) may be a median of valid block motion vectors in the vertical direction (i.e., GMV_{y}=median(all valid MV_{y})).

A confidence calculation module 444 may determine the confidence 445 of the global motion vector. In an implementation, the global confidence value (Conf) 445 may be computed as follows. The confidence value of the horizontal global motion vector GMVₓ is

Conf_{y}=NCC(X′+GMVₓ, X). (6)

In equation (6), X′ and X are each a whole image projection 442 in the horizontal direction for the previous image and the current image, respectively. X′+GMVₓ stands for moving X′ by the offset of GMVₓ, which aligns X′ to X by the offset of GMVₓ before NCC.

The confidence value of the vertical global motion vector GMV_{y} is

Conf_{y}=NCC(Y′+GMV_{y}, Y). (7)

In equation (7), Y′ and Y are each a whole image projection 442 in the vertical direction for the previous image and the current image, respectively. Y′+GMV_{y} stands for moving Y′ by the offset of GMV_{y}, which aligns Y′ to Y by the offset of GMV_{y} before NCC.

The overall global confidence value (Conf) 445 for the global motion vector is the average of the horizontal global confidence value and the vertical global confidence value. In other words, Conf=average(Confₓ,Conf_{y}).

The output of the global motion detector 412 may be provided to the fusion module 420. For example, the global motion transform 432 (i.e., global motion vector) and the global confidence value (Conf) 445 may be provided to the fusion module 420. The decision of choosing the feature-based transform 430 or the global motion transform 432 is based on the global confidence value (Conf) 445 and the number of feature pairs 324, 326.

If the confidence 445 of global motion vector is more than a second predefined threshold and the number of feature pairs 324, 326 from the feature-based DIS is less than a third predefined threshold, the global motion vector is selected as the transform 434 to be used to generate the compensation matrix. Otherwise, the feature-based DIS transform 430 is used since there are enough features 324, 326 to support it.

FIG. 5 is an example illustrating partitioning of an image 508 into slices 546, 548 and blocks 550. The image 508 may be partitioned into a certain number of horizontal slices 546 and vertical slices 548. In one approach, the image 508 may be partitioned into equal N horizontal slices 546 and vertical slices 548. In another approach, the image 508 may be partitioned into a different number of horizontal slices 546 and vertical slices 548. In this example, the image 508 has five horizontal slices 546 and five vertical slices 548.

The overlap of the horizontal slices 546 and vertical slices 548 partitions the image 508 into blocks 550. Therefore, the image 508 is virtually partitioned into N×N blocks 550. In this example, the image 508 is partitioned into 5×5 blocks 550.

Horizontal slice projections 541a (X₁, . . . , X_{N}) may be determined according to equation (2). The whole image horizontal projection X 542a may be determined according to equation (3).

Vertical slice projections 541b (Y₁, . . . , Y_{N}) may be determined according to equation (4). The whole image vertical projection Y 542b may be determined according to equation (5).

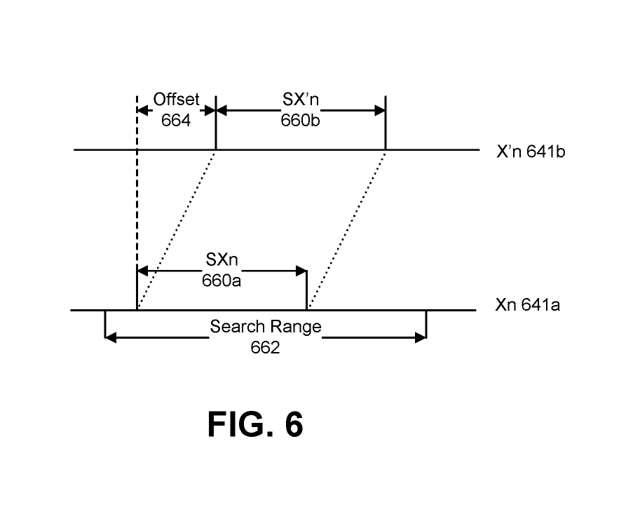

FIG. 6 is an example illustrating a block motion vector determination. SX_{n′} 660b is a horizontal line segment (e.g., partition) on a previous horizontal slice projection X_{n′} 641b for a given block 550. SXₙ 660a is a horizontal line segment on a current horizontal slice projection Xₙ 641a within the search range 662 of the given block 550.

In an implementation, the line segment SX_{n′} 660b may be located on the previous horizontal slice projection X_{n′} 641b for the current block i. A search for SX_{n′} 660b on the current horizontal slice projection Xₙ 641a may be performed within a certain search range 662. The line segment SX_{n′} 660b may be compared with line segments SXₙ 660a on Xₙ 641a. For example, the smallest sum of absolute difference (SAD) and its location on Xₙ 641a may be found. The offset 664 between SX_{n′} 660b and SXₙ 660a is the horizontal motion vector (MVₓ) of block i in the horizontal direction.

The above procedures may be applied on the vertical slice projections 541b to calculate a vertical motion vector (MV_{y}).

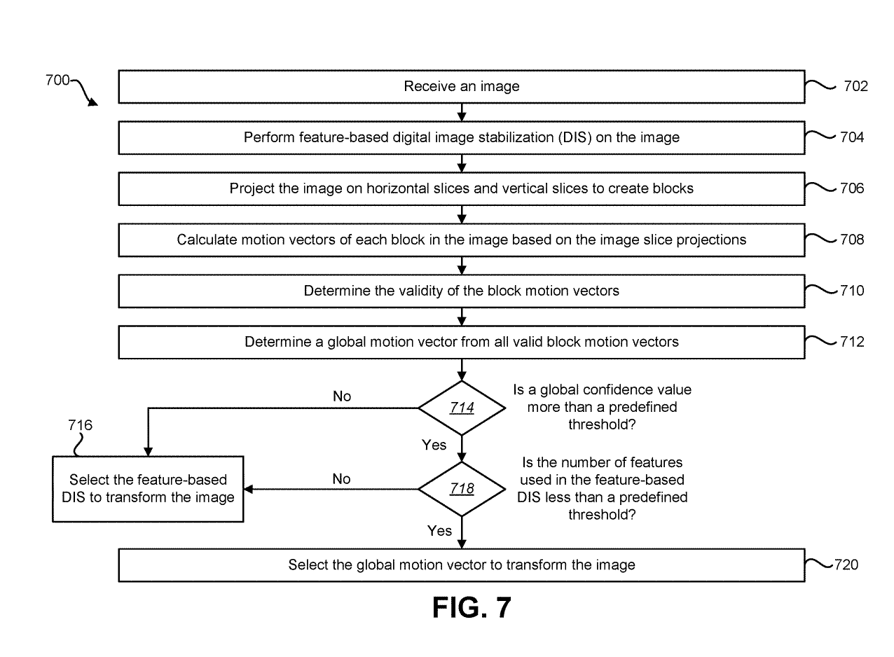

FIG. 7 is a flow diagram illustrating another method 700 for performing digital image stabilization. The method 700 may be implemented by an electronic device 102. For example, the method 700 may be implemented by an image processor 104 of the electronic device 102.

The electronic device 102 may receive 702 an image 108. The electronic device 102 may perform 704 feature-based digital image stabilization (DIS) on the image 108. The feature-based DIS may generate a transform 330 based on one or more features 324, 326 in the image 108 and a previous image 108.

The electronic device 102 may project 706 the image 108 on horizontal slices 546 and vertical slices 548 to create blocks 550. This may be accomplished as described in connection with FIGS. 4 and 5. For example, horizontal slice projections Xₙ 541a may be determined according to equation (2) and a whole image horizontal projection X 542a may be determined according to equation (3). Vertical slice projections Yₙ 541b may be determined according to equation (4) and a whole image vertical projection Y 542b may be determined according to equation (5).

The electronic device 102 may calculate 708 motion vectors of each block 550 in the image 108 based on the image slice projections 541. For example, the offset 664 between line segment SX_{n′} 660b on a previous horizontal slice projection X ₙ′ 641b and a corresponding line segment SXₙ 660a in the current horizontal slice projection Xₙ 641a is the horizontal motion vector (MVₓ) of block i in the horizontal direction.

The electronic device 102 may determine 710 the validity of the block motion vectors. For example, for the horizontal motion vectors (MVₓ), the electronic device 102 may align line segments SX ₙ′ 660b and SXₙ 660a. The electronic device 102 may determine the motion vector confidence value for a given block motion vector as NCC between SX_{n′} 660b and SXₙ 660a. If the motion vector confidence value is greater than a first predefined threshold, then the block motion vector is considered valid.

The electronic device 102 may determine 712 a global motion vector from all valid block motion vectors. The global motion vector includes a horizontal component and a vertical component. A horizontal global motion vector (GMVₓ) may be a median of valid block motion vectors in the horizontal direction (i.e., GMVₓ=median(all valid MVₓ)). A vertical global motion vector (GMV_{y}) may be a median of valid block motion vectors in the vertical direction (i.e., GMV_{y}=median(all valid MV_{y})).

The electronic device 102 may determine 714 whether a global confidence value (Conf) is greater than a second predefined threshold. The confidence value (Confₓ) of the horizontal global motion vector GMVₓ may be determined according to equation (6). The confidence value (Conf_{y}) of the vertical global motion vector GMV_{y} may be determined according to equation (7). The overall global confidence value (Conf) for the global motion vector is the average of the horizontal global confidence value and the vertical global confidence value. In other words, Conf=average(Confₓ,Conf_{y}).

If the global confidence value (Conf) is not greater than the predefined threshold, then the electronic device 102 may select 716 the feature-based DIS to transform the image 108. The electronic device 102 may generate the compensation matrix using the feature-based DIS transform 330.

If the global confidence value (Conf) is greater than the predefined threshold, then the electronic device 102 may determine 718 whether the number of features 324, 326 used in the feature-based DIS is less than a third predefined threshold. If the number of features 324, 326 is not less than the predefined threshold, the electronic device 102 may select 716 the feature-based DIS to transform the image 108. If the number of features 324, 326 is less than the predefined threshold, the electronic device 102 may select 720 the global motion vector to transform the image 108.

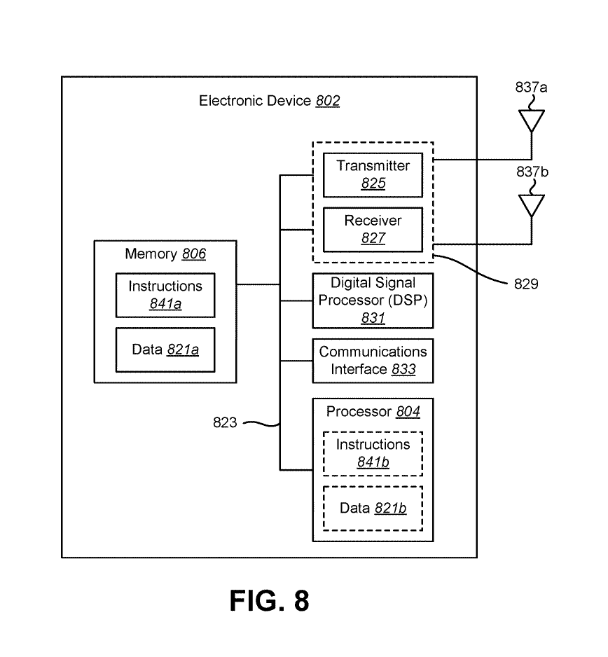

FIG. 8 illustrates certain components that may be included within an electronic device 802. The electronic device 802 may be or may be included within a camera, video camcorder, digital camera, cellular phone, smart phone, computer (e.g., desktop computer, laptop computer, etc.), tablet device, media player, television, automobile, personal camera, action camera, surveillance camera, mounted camera, connected camera, robot, aircraft, drone, unmanned aerial vehicle (UAV), healthcare equipment, gaming console, personal digital assistants (PDA), set-top box, etc.

The electronic device 802 includes a processor 804. The processor 804 may be a general purpose single- or multi-chip microprocessor (e.g., an ARM), a special purpose microprocessor (e.g., a digital signal processor (DSP)), a microcontroller, a programmable gate array, etc. The processor 804 may be referred to as a central processing unit (CPU). Although just a single processor 804 is shown in the electronic device 802, in an alternative configuration, a combination of processors (e.g., an ARM and DSP) could be used.

The electronic device 802 also includes memory 806. The memory 806 may be any electronic component capable of storing electronic information. The memory 806 may be embodied as random access memory (RAM), read-only memory (ROM), magnetic disk storage media, optical storage media, flash memory devices in RAM, on-board memory included with the processor, erasable programmable read-only (EPROM) memory, electrically erasable programmable read-only (EEPROM) memory, registers, and so forth, including combinations thereof.

Data 821a and instructions 841a may be stored in the memory 806. The instructions 841a may be executable by the processor 804 to implement one or more of the methods described herein. Executing the instructions 841a may involve the use of the data that is stored in the memory 806. When the processor 804 executes the instructions 841, various portions of the instructions 841b may be loaded onto the processor 804, and various pieces of data 821b may be loaded onto the processor 804.

The electronic device 802 may also include a transmitter 825 and a receiver 827 to allow transmission and reception of signals to and from the electronic device 802. The transmitter 825 and receiver 827 may be collectively referred to as a transceiver 829. One or multiple antennas 837a-b may be electrically coupled to the transceiver 829. The electronic device 802 may also include (not shown) multiple transmitters, multiple receivers, multiple transceivers and/or additional antennas.

The electronic device 802 may include a digital signal processor (DSP) 831. The electronic device 802 may also include a communications interface 833. The communications interface 833 may allow or enable one or more kinds of input and/or output. For example, the communications interface 833 may include one or more ports and/or communication devices for linking other devices to the electronic device 802. Additionally or alternatively, the communications interface 833 may include one or more other interfaces (e.g., touchscreen, keypad, keyboard, microphone, camera, etc.). For example, the communication interface 833 may enable a user to interact with the electronic device 802.

The various components of the electronic device 802 may be coupled together by one or more buses, which may include a power bus, a control signal bus, a status signal bus, a data bus, etc. For the sake of clarity, the various buses are illustrated in FIG. 8 as a bus system 823.

In accordance with the present disclosure, a circuit, in an electronic device, may be adapted to perform feature-based digital image stabilization (DIS) on an image. The same circuit, a different circuit, or a second section of the same or different circuit may be adapted to perform global motion detection on the image. The same circuit, a different circuit, or a third section of the same or different circuit may be adapted to determine whether to use the feature-based DIS on the image or the output of the global motion detection to correct the feature-based DIS. In addition, the same circuit, a different circuit, or a fourth section of the same or different circuit may be adapted to control the configuration of the circuit(s) or section(s) of circuit(s) that provide the functionality described above.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The term “processor” should be interpreted broadly to encompass a general purpose processor, a central processing unit (CPU), a microprocessor, a digital signal processor (DSP), a controller, a microcontroller, a state machine, and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a DSP and a microprocessor, a plurality of microprocessors, one or more microprocessors in conjunction with a DSP core, or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

The functions described herein may be implemented in software or firmware being executed by hardware. The functions may be stored as one or more instructions on a computer-readable medium. The terms “computer-readable medium” or “computer-program product” refers to any tangible storage medium that can be accessed by a computer or a processor. By way of example, and not limitation, a computer-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed or computed by the computing device or processor. As used herein, the term “code” may refer to software, instructions, code or data that is/are executable by a computing device or processor.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio and microwave, then the coaxial cable, fiber optic cable, twisted pair, DSL, or wireless technologies such as infrared, radio and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

Further, it should be appreciated that modules and/or other appropriate means for performing the methods and techniques described herein, can be downloaded and/or otherwise obtained by a device. For example, a device may be coupled to a server to facilitate the transfer of means for performing the methods described herein. Alternatively, various methods described herein can be provided via a storage means (e.g., random access memory (RAM), read-only memory (ROM), a physical storage medium such as a compact disc (CD) or floppy disk, etc.), such that a device may obtain the various methods upon coupling or providing the storage means to the device.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A method of digital image stabilization, comprising:
performing feature-based digital image stabilization (DIS) on an image; and
using output of a global motion detector to correct the feature-based DIS on the image.

2. The method of claim 1, wherein using output of the global motion detector comprises:
projecting the image on horizontal slices and vertical slices to create blocks;
calculating motion vectors of each block in the image;
determining if at least one block motion vector is a valid block motion vector; and
determining a global motion vector from all valid block motion vectors.

3. The method of claim 2, wherein calculating motion vectors of each block comprises comparing a segment in each slice to a corresponding segment in a slice of a previous image.

4. The method of claim 2, wherein determining whether a given block motion vector is valid comprises:
determining a motion vector confidence value for the given block motion vector; and
comparing the motion vector confidence value to a first predefined threshold.

5. The method of claim 2, wherein the global motion vector comprises a horizontal global motion vector that is a median of valid block motion vectors in a horizontal direction, and a vertical global motion vector that is a median of valid block motion vectors in a vertical direction.

6. The method of claim 5, wherein using output of the global motion detector comprises comparing a global confidence value to a second predefined threshold and comparing a number of features used in the feature-based DIS to a third predefined threshold.

7. The method of claim 6, wherein determining the global confidence value comprises:
determining a horizontal global confidence value for the horizontal global motion vector;
determining a vertical global confidence value for the vertical global motion vector; and
determining the global confidence value as an average of the horizontal global confidence value and the vertical global confidence value.

8. The method of claim 6, wherein using output of the global motion detector to correct the feature-based DIS on the image comprises selecting the global motion vector to transform the image when the global confidence value is more than the second predefined threshold and the number of features used in the feature-based DIS is less than the third predefined threshold.

9. An electronic device configured for digital image stabilization, comprising:
a processor;
memory in communication with the processor; and
instructions stored in the memory, the instructions executable by the processor to:
perform feature-based digital image stabilization (DIS) on an image; and
use output of a global motion detector to correct the feature-based DIS on the image.

10. The electronic device of claim 9, wherein the instructions executable to use output of the global motion detector comprise instructions executable to:
project the image on horizontal slices and vertical slices to create blocks;
calculate motion vectors of each block in the image;
determine if at least one block motion vector is a valid block motion vector; and
determine a global motion vector from all valid block motion vectors.

11. The electronic device of claim 10, wherein instructions executable to determine whether a given block motion vector is valid comprise instructions executable to:
determine a motion vector confidence value for the given block motion vector; and
compare the motion vector confidence value to a first predefined threshold.

12. The electronic device of claim 10, wherein the global motion vector comprises a horizontal global motion vector that is a median of valid block motion vectors in a horizontal direction, and a vertical global motion vector that is a median of valid block motion vectors in a vertical direction.

13. The electronic device of claim 12, wherein the instructions executable to use output of the global motion detector comprise instructions executable to compare a global confidence value to a second predefined threshold and compare a number of features used in the feature-based DIS to a third predefined threshold.

14. The electronic device of claim 13, wherein the instructions executable to use output of the global motion detector to correct the feature-based DIS on the image comprise instructions executable to select the global motion vector to transform the image when the global confidence value is more than the second predefined threshold and the number of features used in the feature-based DIS is less than the third predefined threshold.

15. A computer-program product for digital image stabilization, comprising a non-transitory tangible computer-readable medium having instructions thereon, the instructions comprising:
code for causing an electronic device to perform feature-based digital image stabilization (DIS) on an image; and
code for causing the electronic device to use output of a global motion detector to correct the feature-based DIS on the image.

16. The computer-program product of claim 15, wherein the code for causing the electronic device to use output of the global motion detector comprises:
code for causing the electronic device to project the image on horizontal slices and vertical slices to create blocks;
code for causing the electronic device to calculate motion vectors of each block in the image;
code for causing the electronic device to determine if at least one block motion vector is a valid block motion vector; and
code for causing the electronic device to determine a global motion vector from all valid block motion vectors.

17. The computer-program product of claim 16, wherein code for causing the electronic device to determine whether a given block motion vector is valid comprises:
code for causing the electronic device to determine a motion vector confidence value for the given block motion vector; and
code for causing the electronic device to compare the motion vector confidence value to a first predefined threshold.

18. The computer-program product of claim 16, wherein the global motion vector comprises a horizontal global motion vector that is a median of valid block motion vectors in a horizontal direction, and a vertical global motion vector that is a median of valid block motion vectors in a vertical direction.

19. The computer-program product of claim 18, wherein the code for causing the electronic device to use output of the global motion detector comprises code for causing the electronic device to compare a global confidence value to a second predefined threshold and compare a number of features used in the feature-based DIS to a third predefined threshold.

20. The computer-program product of claim 19, wherein the code for causing the electronic device to use output of the global motion detector to correct the feature-based DIS on the image comprises code for causing the electronic device to select the global motion vector to transform the image when the global confidence value is more than the second predefined threshold and the number of features used in the feature-based DIS is less than the third predefined threshold.
